(19) United States
(12) Patent Application Publication
(10) Pub. No.: US 2015/0226231 A1
(43) Pub. Date: Aug. 13, 2015

(54) Fan Blade Removal Panel

(71) Applicant: United Technologies Corporation, Hartford, CT (US)

(72) Inventor: James R. Murdock, Tolland, CT (US)

(21) Appl. No.: 14/515,184

(22) Filed: Oct. 15, 2014

Related U.S. Application Data
(60) Provisional application No. 61/939,572, filed on Feb. 13, 2014.

(51) Int. Cl. F04D 29/40; F02C 3/04

(52) U.S. Cl. CPC F04D 29/403; F02C 3/04; F05D 2230/70; F05D 2220/32

(57) ABSTRACT

A fan section of a gas turbine engine is disclosed. The fan section may comprise a fan having a hub and a plurality of blades extending radially from the hub. The fan section may further comprise a fan case surrounding the fan and an inlet structure located upstream of the fan and defining at least a portion of an airflow path leading to the fan. The inlet structure may have at least one panel removably connected to at least one structural element of the gas turbine engine, and an opening may be exposed when the panel is disconnected from the gas turbine engine. The opening may provide clearance for removal of at least one of the plurality of blades from the hub.

### CROSS-REFERENCE TO RELATED APPLICATION

This Application is a non-provisional patent application claiming priority under 35 USC §119(e) to U.S. Provisional Patent Application Ser. No. 61/939,572 filed on Feb. 13, 2014.

### FIELD OF THE DISCLOSURE

The present disclosure generally relates to gas turbine engines and, more specifically, relates to gas turbine engines having fan stage inlets with removable panels to provide clearance for fan blade removal.

### BACKGROUND

Gas turbine engines are internal combustion engines used to provide thrust to an aircraft or to provide power for land-based applications. In general, a gas turbine engine may consist of a fan section, a core engine located downstream of the fan section, and a nacelle surrounding the fan section and the core engine. The fan section may consist of a fan which may include a plurality of blades connected to a hub, a fan case surrounding the fan, and a fan stage inlet which guides incoming airflow to the fan. During operation, air may be drawn into the fan section through the fan stage inlet and it may be accelerated by the rotating blades of the fan. A portion of the accelerated air may then be routed through the core engine where it may be compressed/pressurized and mixed with fuel and combusted to generate hot combustion gases. In addition, energy may then be extracted from the hot combustion gas products in a turbine section prior to their exhaustion through an exhaust nozzle which may provide forward thrust to an associated aircraft or power if used in other applications.

In recent efforts to reduce gas turbine engine size and weight and improve fuel efficiency, there is a desire to shorten the fan stage inlet. Although weight reductions and increases in fuel efficiencies may be achieved by this approach, the shorter fan stage inlets may present challenges for the assembly of the fan and/or for the removal of fan blades from the hub during regular maintenance. In particular, the walls of shorter fan stage inlets may have convergent surfaces with higher curvature compared with longer fan stage inlet designs. The curved wall surfaces in shorter fan stage inlets may interfere with the ability to disengage individual fan blades from the hub by pulling the blades in an axially forward direction with respect to the engine central axis. In particular, in some inlet designs, the tips of the fan blades may hit the wall of the inlet as they are pulled axially forward during disengagement. As a result, maintenance of the fan blades in gas turbine engines with shorter fan stage inlets may require removal/disassembly of the entire fan from the fan section/nacelle to gain access to the fan blades. However, this approach may be a more arduous endeavor than simply removing/replacing the fan blades individually from an assembled fan section.

In order to provide clearance for removal of an individual fan blade from a gas turbine engine fan, U.S. Patent Application Number U.S. 2001/0031198 describes a recess or pocket formed in a fan containment case. In particular, the recess provides an opening allowing a fan blade to be pulled out from the hub of the fan in a radially outward direction with respect to a rotation axis of the fan. While effective, the recess does not provide clearance for removal of fan blades which are disengaged from the fan in an axially forward direction.

Clearly, there is a need for improved strategies for providing clearance for fan blade removal in gas turbine engines.

### SUMMARY OF THE DISCLOSURE

In accordance with one aspect of the present disclosure, a fan section of a gas turbine engine is disclosed. The fan section may comprise a fan having a hub and a plurality of blades extending radially from the hub. The fan section may further comprise a fan case surrounding the fan and an inlet structure located upstream of the fan and defining at least a portion of an airflow path leading the fan. The inlet structure may have at least one panel removably connected to at least one structural element of the gas turbine engine, and the panel may expose an opening that provides clearance for removal of at least one of the plurality of blades from the hub when it is removed.

In another refinement, the opening may provide clearance for pulling at least one of the plurality of fan blades away from the hub in an axially forward direction with respect to a central axis of the gas turbine engine.

In another refinement, the panel may be hingedly connected to the inner structure.

In another refinement, the panel may be removably connected to the fan section.

In another refinement, the panel may be removably connected to an inner surface of the fan case.

In another refinement, the fan case may comprise at least one flange extending inwardly from the inner surface of the fan case, and the panel may be removably connected to the at least one flange with at least one mechanical fastener.

In another refinement, the at least one mechanical fastener may be a countersunk screw.

In another refinement, the at least one mechanical fastener may be a quarter-turn fastener.

In another refinement, the panel may extend between about five degrees and about thirty degrees of a circumference of the inlet structure.

In another refinement, the panel may extend about ten degrees of the circumference of the inlet structure.

In accordance with another aspect of the present invention, a gas turbine engine is disclosed. The gas turbine engine may comprise a fan section comprising a fan which may have a hub and a plurality of blades extending radially from the hub. The fan section may further comprise a fan case surrounding the fan and an inlet structure located upstream of the fan and defining at least a portion of an airflow path leading to the fan. The inlet structure may have at least one panel removably connected to at least one structural element of the gas turbine engine, and the panel may expose an opening that provides clearance for removal of at least one of the plurality of blades from the hub when it is removed. The gas turbine engine may further comprise a core engine located downstream of the fan section. The core engine may comprise a compressor section, a combustor located downstream of the compressor section, and a turbine section located downstream of the combustor.

In another refinement, the opening may provide clearance for pulling at least one of the plurality of fan blades away from the hub in an axially forward direction with respect to a central axis of the gas turbine engine.

In another refinement, the panel may be removably connected to the fan section.

In another refinement, the panel may be removably connected to an inner surface of the fan case.

In another refinement, the fan case may comprise at least one flange extending inwardly from the inner surface of the fan case, and the panel may be removably connected to the at least one flange with at least one mechanical fastener.

In another refinement, the at least one mechanical fastener may be a countersunk screw.

In another refinement, the at least one mechanical fastener may be a quarter-turn fastener.

In another refinement, the panel may extend between about five degrees and about thirty degrees of a circumference of the inlet structure.

In another refinement, the panel may extend about ten degrees of the circumference of the inlet structure.

In accordance with another aspect of the present disclosure, a method for removing a fan blade from a fan of a gas turbine engine is disclosed. The method may comprise removing a panel from an inlet structure of a fan section to expose an opening and removing a spinner and a locking feature from a hub of the fan. The method may further comprise aligning the fan blade with the opening, and disengaging the fan blade from the hub by sliding the fan blade axially forward with respect to a central axis of the gas turbine engine.

These and other aspects and features of the present disclosure will be more readily understood when read in conjunction with the accompanying drawings.

### BRIEF DESCRIPTION OF THE DRAWINGS

FIG. 1 is a side cross-sectional view of a gas turbine engine, constructed in accordance with the present disclosure.

FIG. 2 is a front view of a fan section of the gas turbine engine of FIG. 1 shown in isolation.

FIG. 3 is a cross-sectional view through the section 3-3 of FIG. 1, but with a panel removed from the fan section to provide clearance for removal of a fan blade, constructed in accordance with the present disclosure.

FIG. 4 is an expanded view of detail 4 of FIG. 1, constructed in accordance with the present disclosure.

FIG. 5 is an expanded view similar to FIG. 4, but having the panel and a spinner removed from the fan section to provide clearance for removal of the fan blade.

FIG. 6 is an expanded view of detail 6 of FIG. 4, depicting details of a mechanical connection between the panel and a fan case, constructed in accordance with the present disclosure.

FIG. 7 is an expanded view of detail 7 of FIG. 6.

FIG. 8 is a side cross-sectional view similar to FIG. 6, but with the panel removed to provide clearance for fan blade removal.

FIG. 9 is a side cross-sectional view similar to FIG. 6, but showing the panel hingedly connected to the fan case, constructed in accordance with the present disclosure.

FIG. 10 is a flowchart depicting a sequence of steps which may be involved in removing the fan blades from the gas turbine engine, in accordance with a method of the present disclosure.

It should be understood that the drawings are not necessarily drawn to scale and that the disclosed embodiments are sometimes illustrated schematically and in partial views. It is to be further appreciated that the following detailed description is merely exemplary in nature and is not intended to limit the invention or the application and uses thereof. In this regard, it is to be additionally appreciated that the described embodiment is not limited to use in conjunction with a particular type of engine. Hence, although the present disclosure is, for convenience of explanation, depicted and described as certain illustrative embodiments, it will be appreciated that it can be implemented in various other types of embodiments and in various other systems and environments.

### DETAILED DESCRIPTION

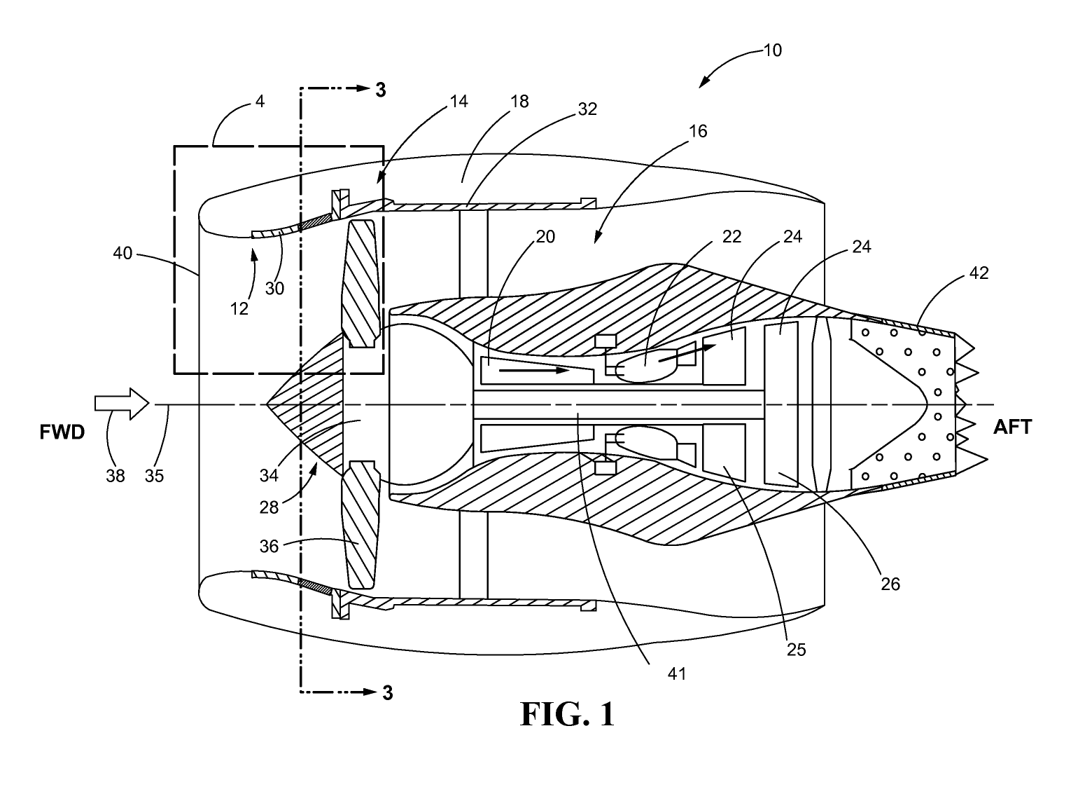

Referring now to the drawings, and with specific reference to FIG. 1, a gas turbine engine 10 is shown. The gas turbine engine 10 may be associated with an aircraft to provide thrust, or it may be used to provide power in other applications. In general, the gas turbine engine 10 may consist of a fan stage inlet 12, a fan section 14, a core engine 16 located downstream of the fan section 14, and a nacelle 18 surrounding the fan section 14 and at least a portion of the core engine 16, as shown. In an upstream to downstream direction, the core engine 16 may include: 1) a compressor section 20 (which may include a low pressure compressor and a high pressure compressor), 2) an annular combustor 22 (although a series of circumferentially spaced ‘can’ combustors may also be used), and 3) a turbine section 24 which may include a high pressure compressor 25 and a low pressure compressor 26. In addition, the fan section 14 may include a fan 28, an inlet structure 30 located upstream of the fan 28, and a fan case 32 surrounding the fan 28. The fan 28 may consist of a hub 34 capable of rotating about an engine central axis 35, and a plurality of blades 36 extending radially from the hub 34.

In operation of the gas turbine engine 10, air 38 may be drawn into the engine 10 through an opening 40 and it may be guided to the fan 28 by the inlet 12. The air 38 may then be accelerated as it passes through the fan 28 due to rotation of the blades 36. A fraction of the accelerated air may then be routed through the core engine 16 where it may be compressed/pressurized in the compressor section 20 and then mixed with fuel and combusted in the combustor(s) 22 to generate hot combustion gases. The hot combustion gases may then expand through and drive the rotation of the turbine section 24 which may, in turn, drive the rotation of the fan 28 and the compressor section 20, as all may be connected on an interconnecting shaft 41. After exiting the turbine section 24, the gases may be exhausted through an exhaust nozzle 42 to provide forward thrust to an associated aircraft or to provide power in other applications.

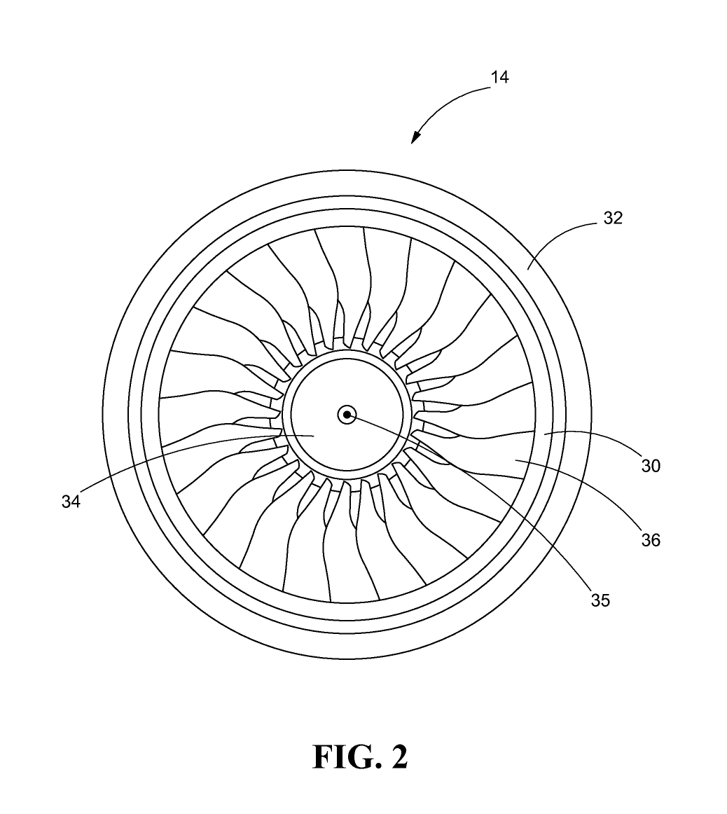

As shown in FIGS. 1-2, the inlet structure 30 may form a portion of the fan stage inlet 12 and may define at least a portion of an air flowpath leading from the opening 40 to the fan 28. In some cases, the inlet structure 30 may have an annular structure and may have curved inner surfaces which may be radially inboard of the tips 44 of the blades 36. Such curved surfaces may impede or block the ability to disengage the blades 36 from the hub 34 by pulling the blades axially forward from the hub 34, as may be required during maintenance or repair of the fan section 14, for example. In particular, the removal of the blades 36 from the hub 34 in this way may become increasingly more difficult as the curvature of the inlet structure 30 increases, such as in shorter fan stage inlet designs.

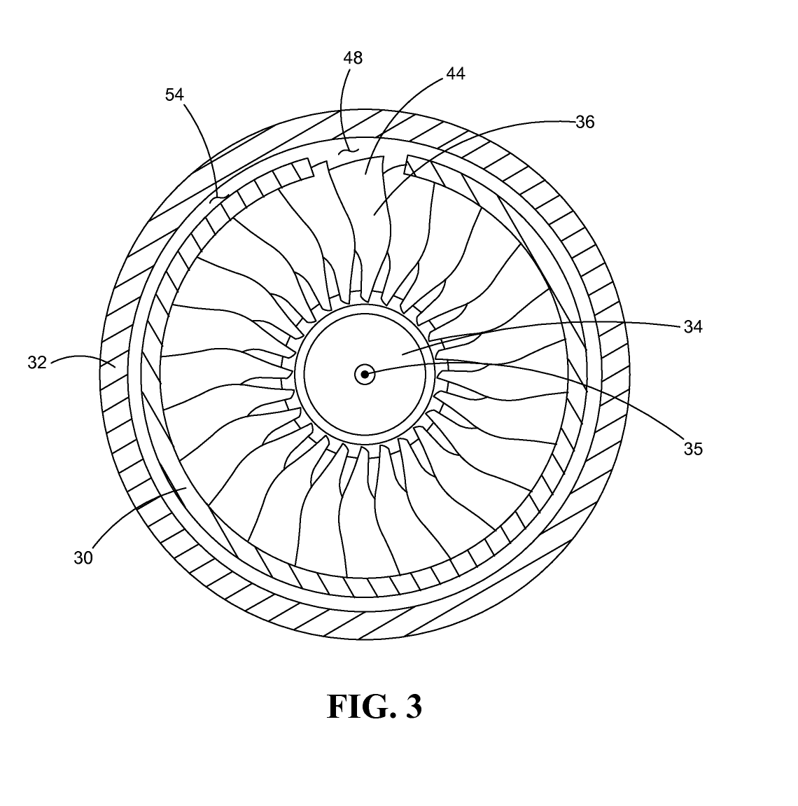

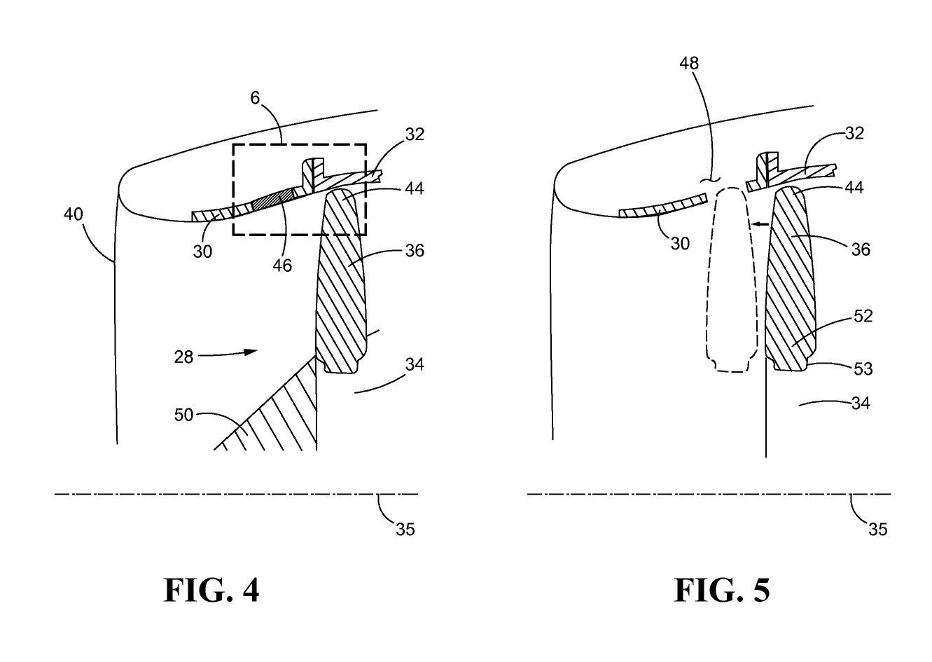

In order to provide clearance for fan blade removal, the inlet structure 30 may have one or more panels 46 which may be removed from the fan section 14, as shown in FIGS. 3-5. When the panel 46 is removed from the fan section 14, an opening 48 located upstream of the fan 28 may be exposed which may be suitably dimensioned to provide sufficient space for removal of one or more blades 36 from the hub 34 (see FIG. 3 and FIG. 5). In practice, the panel 46 and a spinner 50 of the hub 34 may first be removed from the fan section 14 (see FIG. 5). A root 52 of the blade 36 may then be disengaged from a slot 53 formed in the hub 34 by sliding the blade 36 axially forward with respect to the engine central axis 35. The blade 36 may then be pulled out of the hub 34 using the clearance provided by the opening 48 when the panel 46 is removed, as best depicted in FIG. 5. In particular, the opening 48 may provide temporary clearance as a tip 44 of the blade passes closely by the inlet structure 30 as the blade 36 is removed. Accordingly, the removable panel 46 may allow for convenient assembly or repair of the blades 36 of the fan 28, even in gas turbine engines having highly curved inlet walls and/or shorter fan stage inlet designs.

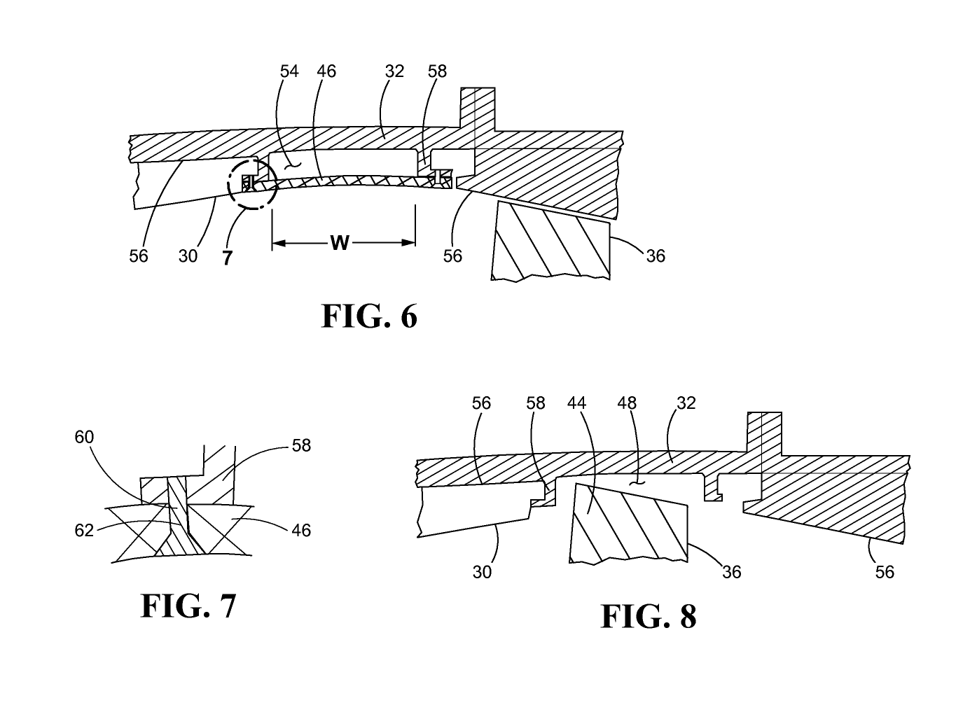

The structure of the panel 46 is more clearly shown in FIG. 6. The panel 46 may have a width, w, that is at least as wide as the tip 44 of at least one blade 36, such that the tip of at least one blade 36 may temporarily protrude into the opening 48 left by the panel 46 when it is removed. As a non-limiting possibility, the panel 46 may extend between about 5° and about 30° of the circumference of the inlet structure 30 depending on the number of blades 36 in the fan 28 and other design considerations, although it may span other angles as well. For example, it may span about 10° of the circumference of the inlet structure 30. In addition, the length of the panel 46 may be at least long enough to provide sufficient space to allow complete disengagement of the blade 36 from the hub 34 in the axial forward direction when the panel is removed. Accordingly, the length and width of the panel 46 may depend on the size of the blades 36 and other clearance considerations. Furthermore, the panel 46 may be formed from various materials such as, but not limited to, a composite material or aluminum, although other suitable materials may also be used in some circumstances.

The panel 46 may be removably connected to at least one structural element of the gas turbine engine 10, such as a structural element of the fan section 14 or of the nacelle 18. As one possibility, the panel 46 may be removably connected to the fan case 32, as shown in FIGS. 6-8. In such an arrangement, the opening 48 may be provided by a space 54 located between the panel 46 and an inner surface 56 of the fan case 32. Although various connection arrangements are possible, the panel 46 may be removably connected to a structural element of the fan case 32, such as one or more flanges 58. For example, the flange(s) 58 may extend inwardly from the inner surface 56 and the panel 46 may be removably connected to the flange(s) 58 using one or more mechanical fasteners 60, as best shown in FIG. 7. Suitable mechanical fasteners 60 may be countersunk screws 62 as these types of screws may minimize obstructions in the airflow path defined by the inlet structure 30, thereby minimizing aerodynamic impact on the engine 10. Alternatively, they may be quarter-turn fasteners or countersunk quarter-turn fasteners. However, other types of fasteners or removable connections may also be used in some situations.

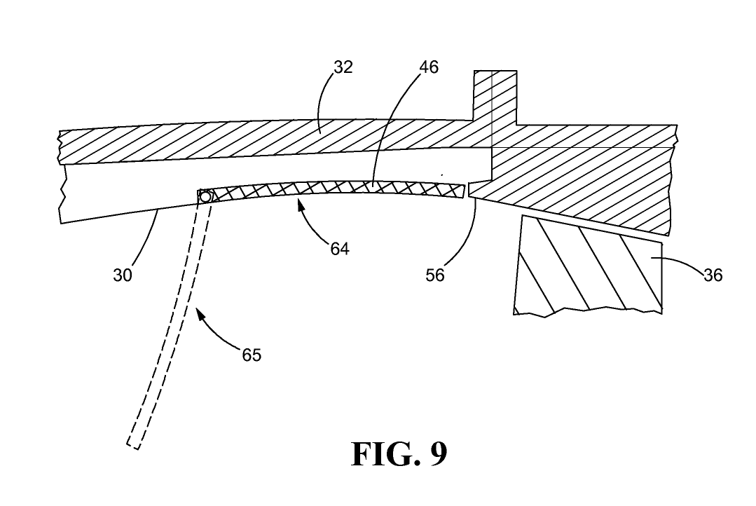

Turning now to FIG. 9, the panel 46 may be hingedly connected to a structural element of the fan section 14 or the nacelle 18 as an alternative arrangement. For example, the panel 46 may be hingedly connected to the inlet structure 30. In this arrangement, the panel 46 may be capable of translating between a closed position 64, in which the panel 46 may form a continuous portion of the inlet structure wall, and an open position 65, in which the panel 46 may be rotated about a hinged connection 68 to expose the opening 48. The closed position 64 may be selected during normal operation or during parking/storage, and a locking feature may be used to retain the panel 46 in the closed position 64 (not shown). When desired, the panel 46 may be translated to the open position 65 to provide clearance for removal of one or more blades 36, such as during maintenance or repair of the fan 28. As will be appreciated, the location of the hinged connection 68 may vary depending on various design considerations.

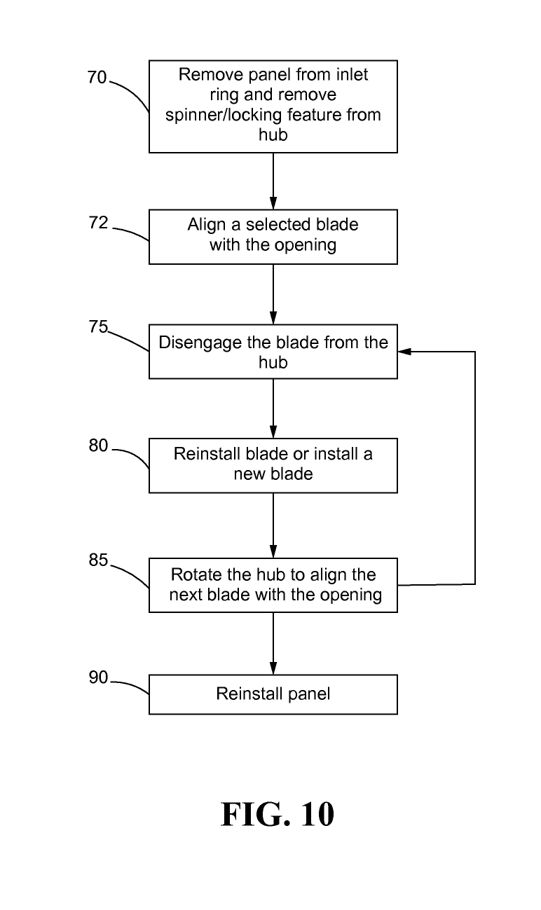

Referring now to FIG. 10, a series of steps which may be involved in removing the blades 36 from the gas turbine engine 10 are depicted. Beginning with a first block 70, the panel 46 may be removed from the inlet structure 30 to expose the opening 48. As one possibility, this may be achieved by removing the mechanical fastener(s) 60 which connect the panel 46 to the fan case 32. Alternatively, if the panel 46 is hingedly connected to the fan section 14, as shown in FIG. 9, it may be translated to the open position 65 to expose the opening 48. In addition, the spinner 50 may be removed from the hub 34 and a blade locking feature (not shown) may also be removed from the hub 34 to expose the blade root(s) 52, as will be apparent to those skilled in the art.

According to a next block 72, a selected blade 36 may be aligned with the opening 48 that is exposed upon removal of the panel 46 by appropriately rotating the hub 34. The selected blade 36 be may then removed from the hub 34 by sliding the blade 36 axially forward to disengage the root 52 from the slot 53 (see FIG. 5) according to a next block 75. If desired, the blade 36 may later be replaced in the hub after inspection or repair, or a new blade 36 may be installed according to a next block 80. The hub 34 may then be rotated to align the next selected blade 36 with the opening 48 according to a next block 85. As shown, the blocks 75, 80, and 85 may be repeated as necessary until all of the selected blades have been removed and replaced. The panel 46 may then be reinstalled according to a next block 90. It is noted here that in some situations the reinstallation of the blade 36 or the installation of new blades may be carried out after all of the desired blades have been removed (i.e. by the blocks 75 and 85).

It is also noted that the opening 48 may also provide sufficient clearance for the initial installation of the blades 36 in a hub 34 having one or more empty slots 53. In particular, the tip 44 of the blade 36 may be positioned in the opening 48 and the root 52 of the blade may be slid in an axially aft direction to engage the root 52 with the hub 34 (i.e., the reverse process depicted in FIG. 5). The hub 34 may then be rotated to align the next empty slot of the hub 34 with the opening 48 and the next blade 36 may be installed. These steps may be repeated as necessary to complete the installation of the blades 36.

Although the present disclosure generally relates to gas turbine engine applications, it will be understood that the concepts disclosed herein may be implemented in various other applications requiring clearance for blade removal or installation. These and other alternatives are considered equivalents and within the spirit and scope of this disclosure.

### INDUSTRIAL APPLICABILITY

In general, it can therefore be seen that the technology disclosed herein has industrial applicability in a variety of settings including, but not limited to, gas turbine engines. The removable panel disclosed herein may be installed in an inlet structure of a fan stage inlet and it may be removed as needed to provide clearance for maintenance, repair, or installation of the fan blades. Once removed from the inlet structure, the panel may expose an opening that is large enough to provide sufficient space for removal or installation of at least one fan blade. More specifically, the opening may provide clearance for the tips of the fan blades as the fan blade is pulled away from the hub in an axially forward direction (for removal) or as the blade is pushed toward the hub in an axially aft direction (for installation or replacement). Accordingly, the blades may be removed, installed, or replaced one at a time. In this way, the removable panel may improve the ease and convenience of fan blade removal/installation, particularly in gas turbine engines having shorter inlets with more aggressively curved walls which would otherwise obstruct fan blade removal and require removal of the entire fan stage inlet to gain access to the fan blades. In addition, the removable panel may allow for shorter fan stage inlets with more highly curved walls, without compromising the ability to remove/install the fan blades. In this regard, the removable panel may support current efforts to reduce engine weight and improve fuel efficiency by implementing shorter fan stage inlet designs. It is expected that the technology disclosed herein may find wide industrial applicability in areas such as, but not limited to, aerospace and power generation applications.

What is claimed is:

1. A fan section of a gas turbine engine, comprising:
a fan having a hub and a plurality of blades extending radially from the hub;
a fan case surrounding the fan; and
an inlet structure located upstream of the fan and defining at least a portion of an airflow path leading to the fan, the inlet structure having at least one panel removably connected to at least one structural element of the gas turbine engine, the panel exposing an opening that provides clearance for removal of at least one of the plurality of blades from the hub when it is removed.

2. The fan section of claim 2, wherein the opening provides clearance for pulling at least one of the plurality of blades away from the hub in an axially forward direction with respect to a central axis of the gas turbine engine.

3. The fan section of claim 2, wherein the panel is hingedly connected to the inlet structure.

4. The fan section of claim 2, wherein the panel is removably connected to the fan section.

5. The fan section of claim 4, wherein the panel is removably connected to an inner surface of the fan case.

6. The fan section of claim 5, wherein the fan case comprises at least one flange extending inwardly from the inner surface, and wherein the panel is removably connected to the at least one flange with at least one mechanical fastener.

7. The fan section of claim 6, wherein the at least one mechanical fastener is a countersunk screw.

8. The fan section of claim 7, wherein the mechanical fastener is a quarter-turn fastener.

9. The fan section of claim 5, wherein the panel extends between about five degrees and about thirty degrees of a circumference of the inlet structure.

10. The fan section of claim 9, wherein the panel extends about ten degrees of the circumference of the inlet structure.

11. A gas turbine engine, comprising:
a fan section comprising
a fan having a hub and a plurality of blades extending radially from the hub,
a fan case surrounding the fan, and
an inlet structure located upstream of the fan and defining at least a portion of an airflow path leading to the fan, the inlet structure having at least one panel removably connected to at least one structural element of the gas turbine engine, the panel exposing an opening that provides clearance for removal of at least one of the plurality of blades from the hub when it is removed; and
a core engine located downstream of the fan section, the core engine comprising
a compressor section,
a combustor located downstream of the compressor section, and
a turbine section located downstream of the combustor.

12. The gas turbine engine of claim 11, wherein the opening provides clearance for pulling at least one of the plurality of blades away from the hub in an axially forward direction with respect to a central axis of the gas turbine engine.

13. The gas turbine engine of claim 12, wherein the panel is removably connected to the fan section.

14. The gas turbine engine of claim 13, wherein the panel is removably connected to an inner surface of the fan case.

15. The gas turbine engine of claim 14, wherein the fan case comprises at least one flange extending inwardly from the inner surface, and wherein the panel is removably connected to the at least one flange with at least one mechanical fastener.

16. The gas turbine engine of claim 15, wherein the at least one mechanical fastener is a countersunk screw.

17. The gas turbine engine of claim 16, wherein the at least one fastener is a quarter-turn fastener.

18. The gas turbine engine of claim 14, wherein the panel extends between about five degrees and about thirty degrees of a circumference of the inlet structure.

19. The gas turbine engine of claim 18, wherein the panel extends about ten degrees of the circumference of the inlet structure.

20. A method for removing a fan blade from a fan of a gas turbine engine, comprising:
removing a panel from an inlet structure of a fan section to expose an opening, and removing a spinner and a locking feature from a hub of the fan;
aligning the fan blade with the opening; and
disengaging the fan blade from the hub by sliding the fan blade axially forward with respect to a central axis of the gas turbine engine.
